(19) United States
(12) Patent Application Publication
(10) Pub. No.: US 2016/0094697 A1
(43) Pub. Date: Mar. 31, 2016

(54) METHOD OF ANSWERING ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: MIN YANG, Wuhan (CN); XIN-SHU WANG, Wuhan (CN); JIAN-HUNG HUNG, New Taipei (TW)

(21) Appl. No.: 14/543,558

(22) Filed: Nov. 17, 2014

(30) Foreign Application Priority Data
Sep. 30, 2014 (CN) 201410517201.9

(51) Int. Cl. H04M 1/64; H04M 1/57; H04W 4/02

(52) U.S. Cl. CPC H04M 1/64; H04W 4/027; H04M 1/57

(57) ABSTRACT

A method for answering an electronic device includes the following blocks. A predefined speed value is adjusted. An incoming communication requirement is received. A moving speed value is detected. The moving speed value is determined if is greater than the predefined speed value. The incoming communication requirement is answered when the moving speed value is not greater than the predefined speed value.

### CROSS-REFERENCE TO RELATED APPLICATIONS

This application claims priority to Chinese Patent Application No. 201410517201.9 filed on Sep. 30, 2014, the contents of which are incorporated by reference herein.

### FIELD

The present disclosure relates to a method of answering a call or message of an electronic device.

### BACKGROUND

Electronic devices, such as phones are widely used in daily life. A person can answer the phone at his convenience.

### BRIEF DESCRIPTION OF THE DRAWINGS

Implementations of the present technology will now be described, by way of example only, with reference to the attached figures.

FIG. 1 is a block diagram of an embodiment of an electronic device and a wireless accessory.

FIG. 2 is a flowchart of an embodiment of a method of answering a call or message of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

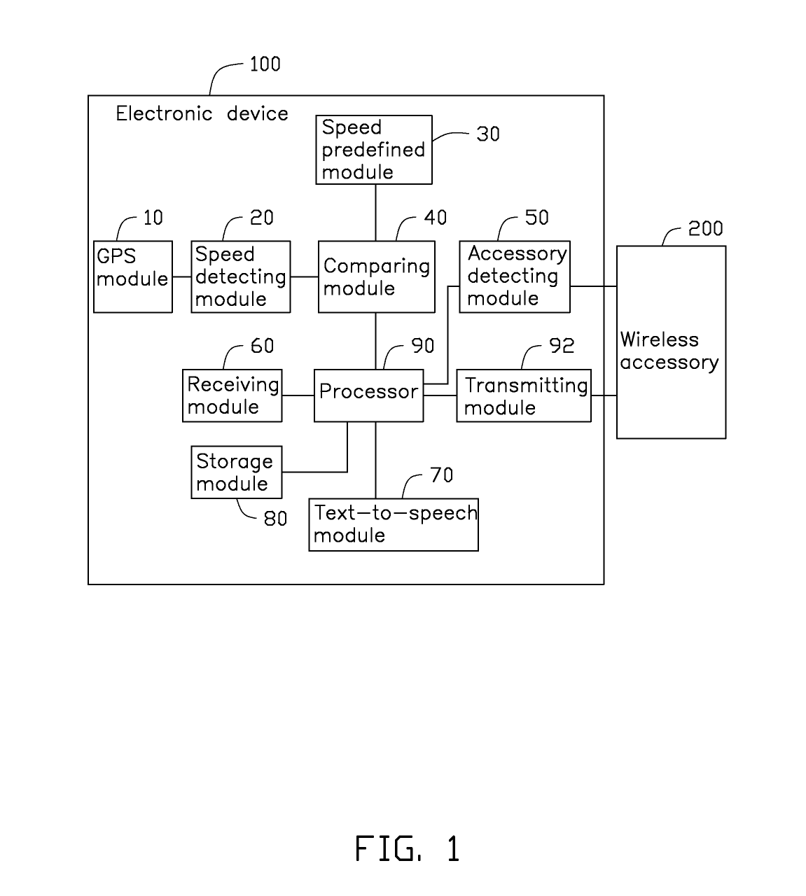

FIG. 1 illustrates an electronic device 100 and a wireless accessory 200 in accordance with an embodiment. The electronic device 100 can be a smart phone, a tablet computer, a laptop computer, a smart watch, a smart glass, and so on. The wireless accessory 200 can be a Bluetooth headset. The electronic device 100 includes a global positioning system (GPS) module 10, a speed detecting module 20, a speed predefined module 30, a comparing module 40, an accessory detecting module 50, a receiving module 60, a text-to-speech module 70, a storage module 80, a processor 90, and a transmitting module 92.

The comparing module 40 is coupled to the speed detecting module 20 and the speed predefined module 30. The speed detecting module 20 is coupled to the GPS module 10. The processor 90 is coupled to the comparing module 40, the accessory detecting module 50, the receiving module 60, the text-to-speech module 70, the storage module 80, the processor 90, and the transmitting module 92.

The GPS module 10 can detect a position of the electronic device 100. The speed receiving module 20 can detect a moving speed value of the electronic device 100. The speed predefined module 30 can receive a configuration of a predefined speed value from a user. The comparing module 40 can determine if the moving speed value is greater than the predefined speed value. The accessory detecting module 50 can detect if the wireless accessory 200 is coupled to the electronic device 100. The receiving module 60 can receive a call and a message. The call and the message can come from a cellular network or the Internet. The storage module 80 can store information of the call and the message. The text-to-speech module 70 can transmit the message to a voice. The transmitting module 92 can transmit data to the wireless accessory 200.

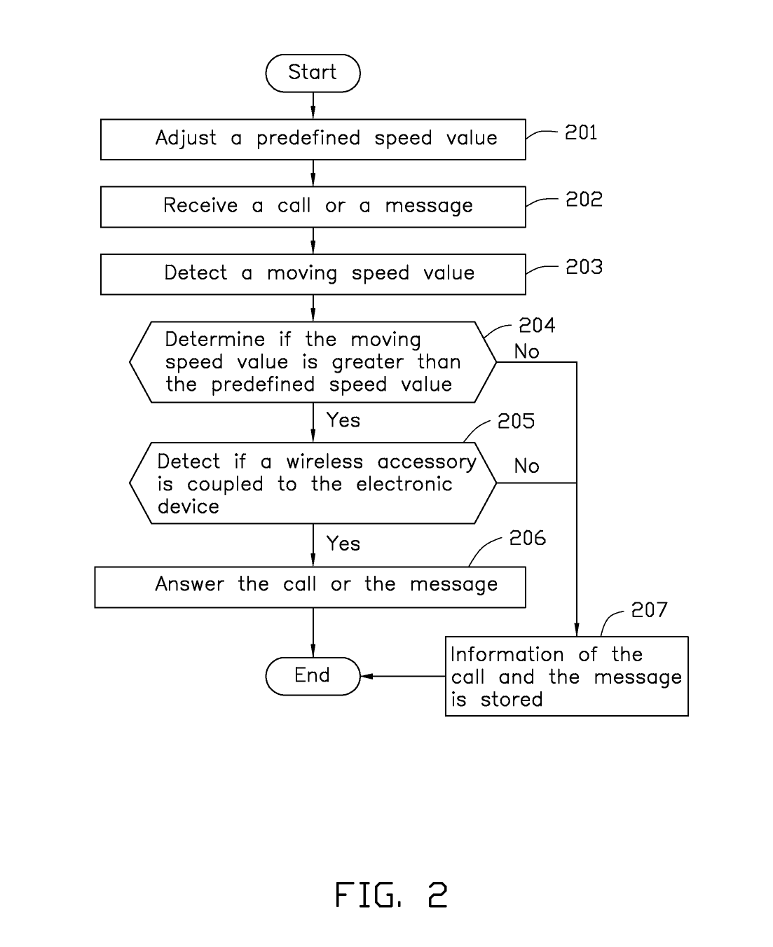

FIG. 2 illustrates a method of answering an electronic device. The example method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 201. The method includes one or more of the following blocks.

At block 201, a speed predefined module defines a configuration of a speed value from a user and adjusts the predefined speed value.

At block 202, a receiving module receives a call or a message. The call or the message can be an incoming communication requirement. The call or the message can come from a cellular network or the Internet.

At block 203, a speed detecting module detects a moving speed value of the electronic device.

At block 204, a comparing module determines if the moving speed value is greater than the predefined speed value. If the moving speed value is not greater than the predefined speed value, the block goes to block 205; if the moving speed value is greater than the predefined speed value, the block goes to block 207.

At block 205, an accessory detecting module detect if a wireless accessory is coupled to the electronic device. If the wireless accessory is coupled to the electronic device, the block goes to block 206; if the wireless accessory is not coupled to the electronic device, the block goes to block 207.

At block 206, the call or the message is answered through the wireless accessory.

At block 207, information of the call and the message can be stored in a storage module.

In other embodiment, if the moving speed value is not greater than the predefined speed value, the electronic device can be directly answered through a load speaker.

The embodiments shown and described above are only examples. Many details are often found in the art such as the other features of a mounting device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A method for answering an electronic device, comprising:
adjusting a predefined speed value;
receiving an incoming communication requirement;
detecting a moving speed value;
determining if the moving speed value is greater than the predefined speed value; and
answering the incoming communication requirement when the moving speed value is not greater than the predefined speed value.

2. The method of claim 1, further comprising holding the incoming communication requirement when the moving speed value is greater than the predefined speed value.

3. The method of claim 1, further comprising recording information of the incoming communication requirement.

4. The method of claim 3, wherein the information comprises a name and a number of the incoming communication requirement.

5. The method of claim 1, wherein the incoming communication requirement is answered through a load speaker.

6. The method of claim 1, wherein the moving speed value is detected through a global positioning system module.

7. The method of claim 1, wherein the incoming communication requirement comprises a call from cellular network.

8. The method of claim 1, wherein the incoming communication requirement comprises a call from Internet.

9. The method of claim 1, further comprising answering the incoming communication requirement through a text-to-speech module and when the moving speed value is greater than the predefined speed value.

10. The method of claim 1, further comprising detecting if a wireless headset is connected to the electronic device, and answering the incoming communication requirement through the wireless headset.

11. A method for answering an electronic device, comprising:
adjusting a predefined speed value;
receiving a call or message;
detecting a moving speed value;
determining if the moving speed value is greater than the speed value;
detecting if an wireless accessory is coupled; and
answering the call or the message when the moving speed value is not greater than the predefined speed value and the wireless accessory is coupled.

12. The method of claim 11, further comprising holding the call when the moving speed value is greater than the predefined speed value.

13. The method of claim 11, further comprising recording information of the call or the message.

14. The method of claim 13, wherein the information comprises a name and a number of the call or the message.

15. The method of claim 11, wherein the call or the message is answered through a load speaker.

16. The method of claim 11, wherein the moving speed value is detected through a global positioning system module.

17. The method of claim 11, wherein the call or the message comes from a cellular network.

18. The method of claim 11, wherein the call or the message comes from the Internet.

19. The method of claim 11, further comprising answering the call or the message through a text-to-speech module and when the moving speed value is greater than the predefined speed value.

20. The method of claim 11, wherein the wireless accessory is a wireless headset.
